(19) United States
(12) Patent Application Publication
(10) Pub. No.: US 2015/0363548 A1
(43) Pub. Date: Dec. 17, 2015

(54) SYSTEMS BIOLOGY APPROACH TO THERAPY

(71) Applicant: COUNTERPOINT HEALTH SOLUTIONS, INC., Bedford, MA (US)

(72) Inventor: Wayne R. Matson, Ayer, MA (US)

(21) Appl. No.: 14/828,211

(22) Filed: Aug. 17, 2015

Related U.S. Application Data
(62) Division of application No. 14/321,569, filed on Jul. 1, 2014.
(60) Provisional application No. 61/841,833, filed on Jul. 1, 2013.
(60) Provisional application No. 61/900,822, filed on Nov. 6, 2013.

(51) Int. Cl. G06F 19/12; G06F 19/00

(52) U.S. Cl. CPC G06F 19/12; G06F 19/3437

(57) ABSTRACT

A method comprising analyzing multiple component data between or among categories of individuals to develop therapeutic lead compounds through analysis of biochemical networks linking the genome, transcriptome, proteome, metabolome, gut microbiome and environmental factors.

### CROSS REFERENCE TO RELATED APPLICATIONS

This application is a divisional patent application based on U.S. patent application Ser. No. 14/321,569, filed Jul. 1, 2015, which in turn, claims priority from U.S. Provisional Application Ser. No. 61/841,833, filed Jul. 1, 2013 and Application Ser. No. 61/900,822, filed Nov. 6, 2013, the contents of which are incorporated herein by reference in their entireties.

### BACKGROUND OF THE INVENTION

The regulatory system of the human body involves a network of interaction among the functions of the genome, transcriptome proteome metabolome gut microbiome and environment. And the interactive effects of the control on the organs of liver, cardiovascular system, brain, kidney, muscle and subcellular functions of the mitochondtiaann nucleus. FIG. 1 represents the traditional understanding of biochemical mechanisms. The DNA makes RNA, the RNA makes proteins , the proteins/enzymes regulate the small molecules, the small molecules come into the system from the gut and the gut gets them from the environment.

The traditional model is limiting in that it does not consider or typically measure the more complex interactions and feed back among the compartments that actually define the functionality or state of health or risk of an individual. Elements of this feedback and control are represented in FIG. 1. The genome DNA affects the aggregate composition of the gut microbiome which affects the small molecules (metabolome). The metabolomc feedback affects the functionality of the genome which in turn affects the transcriptome (the RNA) which affects the proteins/enzymes coded (Proteome) which control the transistions of the small signaling and process molecules, which affect the functionality of the genome proteome and transcriptome. Environment diet, stress and toxins affect the metabolome and gut microbiome, etc.

Referring also to FIG. 2, typically measurements and mapping are done in compartments A1 genetics, A2 gene expression, A3 proteomics, A4 metabolomics. Typically looking for genetic risk factors A1, abberant gene expression A2, unusual disease related proteins A3, molecules or pattrens of molecules that define disease or response (biomarkers) A4. What has been neglected is the mapping of the gut microbiome, particularly the small molecules foot print.

### SUMMARY OF THE INVENTION

The two underlying concepts behind this invention are: First, that disease is not symptoms but rather a failure of the control and feed back of the biochemistry among these functions. What we call disease or symptoms happens later as a result of the failure of control. Thus this failure constitutes the realization of, for instance, single genetic risk factors for development of symptoms and provides a route for reduction of risk.

Second, that we have become focused on the therapeutic notion of an intervention having a single target whereas in reality the approach is to normalize or optimize the functionality of the entire web of interactions or feedback. The web of interactions as a whole is the target. The interaction of these “omic” functions can be mapped with correlation diagrams as well as measurements of individual genes, transcripts, proteins and small molecules to reveal differences in control in a disease state. Mapping the metabolomics proteomic and genomic interactions and correlations reveals multiple points where control in a disease state differes from than in normal individuals. This in turn leads to the specification of multiple compounds for intervention to normalize or optimize the network of interactions.

By way of example, to work from analogy the control network of for instance Presymptommatic or symptomatic Huntington's disease subjects is like a spider web between the branches of genome and environment one part of which has been jammed against one branch. You can't fix such a web by pulling or pushing on one strand.

In one aspect of the invention there is provided a method for developing a treatment for a disease condition in a living organism comprising analyzing multiple component data between or among categories of individuals of normal and diseased individuals to develop therapeutic lead compounds through analysis of biochemical networks linking two or more of the genome, transcriptome, proteome, metabolome, gut microbiome and environmental factors.

In another aspect of the invention cohorts of categories are selected from disease vs. control, responder vs. non responder to therapy, genetic risk vs. non genetic risk subjects, and well vs. non well aged subjects.

The present invention also provides a method of developing adjunctive or new therapeutic approaches using the process of as above described, where the cohort compared is selected from the group consisting of subjects with depression and controls, depression subjects responding and not responding to therapeutic drugs, depression subjects responding and not responding to SSRI's, depression and subjects responding and not responding to ketamine, subjects with mild cognitive impairment and controls, subjects with mild cognative impairment responding and not responding to therapy, subjects with schizophrenia and controls, subjects with schizophrenia responding and not responding to therapy, subjects with Parkinson's Disease and controls, subjects with Parkinsons Disease responding and not responding to therapy, subjects with ALS and controls, subjects with ALS responding and not responding to therapy, subjects with gut disorders and controls, and subjects with gut disorders responding and not responding to therapy. In one embodiment the gut disorder is selected from Celiac Disease, IBD and diverticulitis, anemia and failure to thrive.

Another aspect of the invention comprises profiling coordinately bound metabolome in the periphery or in the proteome.

Still yet another aspect of the invention comprises profiling coordinately and covalently bound metabolome in DNA and RNA, or the metabolome of the gut microbiome.

The present invention also provides a method for developing a treatment for a disease condition in a living organism comprising modeling the metabolome of the gut microbiome of normal and diseased individuals to determine categorical separation of groups and most relevant single factors, or to determine categorical separation of groups using correlative ratios of factors.

In still yet another aspect of the invention there is provided a method for developing a treatment for a disease condition in a living organism, comprising mapping the within and among pathway differences of normal and diseased individuals in cohorts of categories selected from disease vs. control, responder vs. non responder to therapy, genetic risk vs. non genetic risk subjects, and well vs. non well aged subjects, using correlation networks.

The present invention also provides a method for developing a treatment for a disease condition in a living organism comprising determining underlying enzymes, genes and processes of normal and diseased individuals that are revealed by the correlation networks and the compounds, cofactors, and secondary effects that allow intervention to beneficially modify the networks of interactions in the types of cohorts selected from disease vs. control, responder vs. non responder to therapy, genetic risk vs. non genetic risk subjects, and well vs. non well aged subjects.

The invention also provides a method of determining protomemetabolome genome metabolome transcriptome interactions which comprises profiling as distribution of coordinately bound metabolome as a function of the specific individual or class of fractions in a body sample. In one embodiment, the body sample is selected from the group consisting of saliva, blood, a blood fraction, plasma, leucocytes, red blood cells, platelets, biopsy tissue, post mortem tissue, feces, urine, tears and sweat, and the class of fractions is selected from the group consisting of protein, DNA and RNA.

The invention also provides a method of determining protomemetabolome genome metabolome transcriptome interactions, which comprises profiling as distribution of co-valently bound metabolome as a function of a specific individual molecule or class of fractions in a sample. In one embodiment, the sample is selected from the group consisting of saliva, blood, a blood fraction, plasma, leucocytes, red blood cells, platelets, biopsy tissue, post mortem tissue, feces, urine, tears and sweat, and the fraction is selected from the group consisting of protein, RNA and DNA.

### BRIEF DESCRIPTION OF THE DRAWINGS

Further features and advantages of the present invention will be seen from the following detailed description wherein

FIGS. 1 and 2 are correlation mapping diagrams illustrating relationships between “omic” functions according to the prior art;

FIG. 3 schematically illustrates an apparatus used in the method of the present invention;

FIGS. 4-6 show the relationships between compounds in the tyrosine tryptophan purine sulpher amino acid pathways;

FIGS. 7-9 show correlative linkages with the gut metabolite IPA for controlled, presymptomatic and symptomatic HD subjects;

FIGS. 10-12 show correlative relationships of methionine in the sulpher amino acid pathway;

FIGS. 13, 14a, 14b and 14c show changes in specific pathways of tyrosine tryptophan and purines which are linked to the amino acid pathway;

FIG. 15 shows separate of HD and control subjections using correlation frequency distribution;

FIG. 16 shows the KEGG pathway database network for tryptophan.

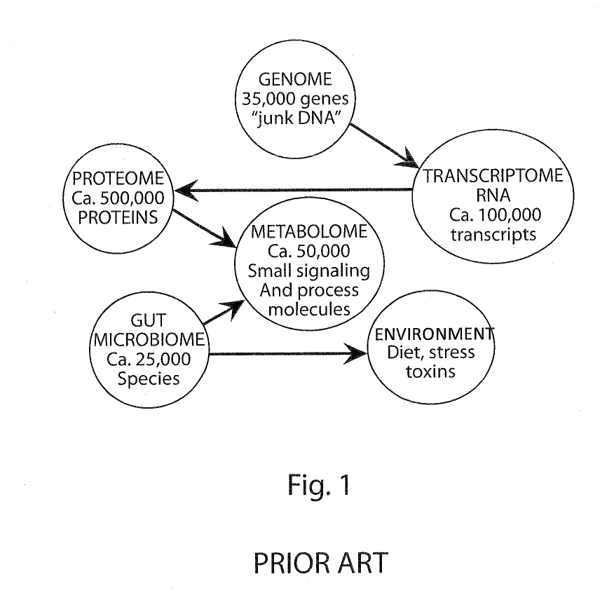

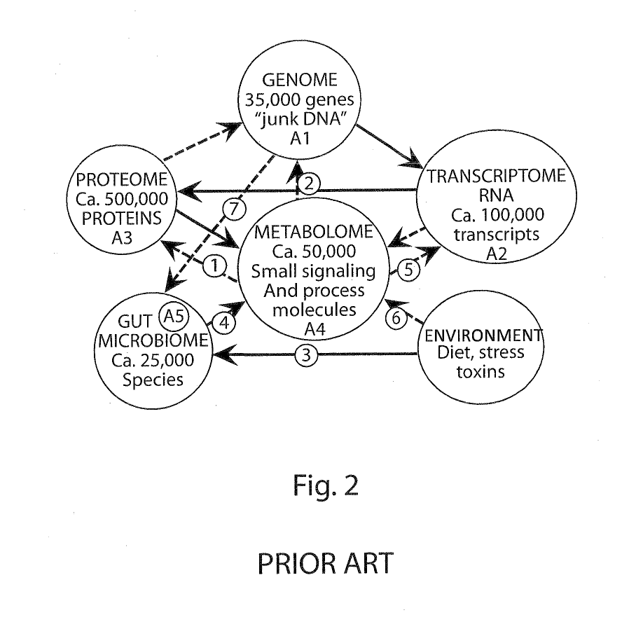

### DETAILED DESCRIPTION OF PREFERRED EMBODIMENTS

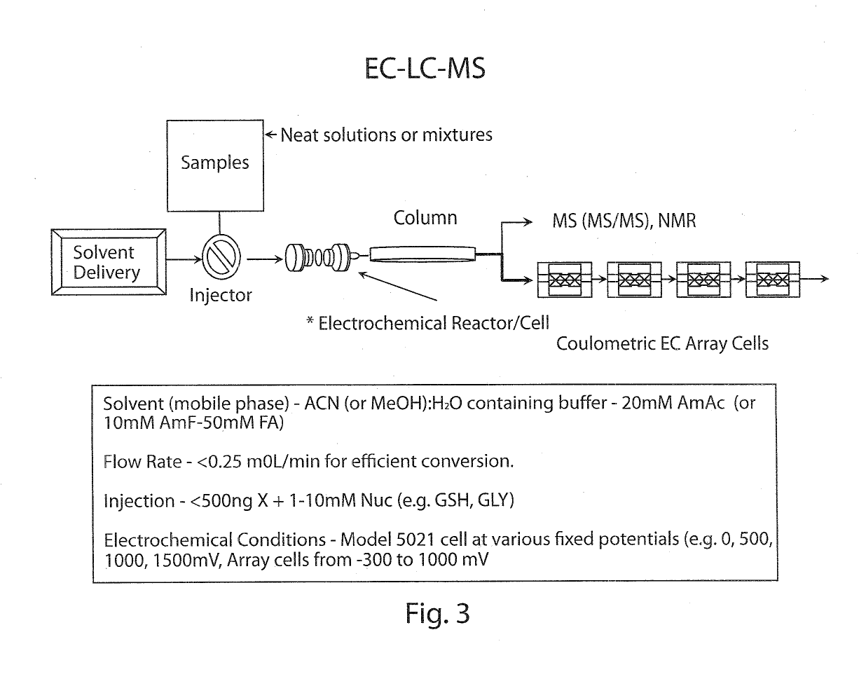

The present invention employs the analysis procedures using a multi-electrode LCEC array as illustrated in FIG. 3, following the teachings of my U.S. Pat. 6,210,970 and my PCT Application PCT/US2013/033918. Peaks observed from the electrochemical array represent electron transfers (oxidation, reduction), while molar equivalent of electrons is measured as the current. For the initial purposes of the study, the data was exported for compounds in tyrosine, tryptophan and purine pathways that were hypothesized to be affected.

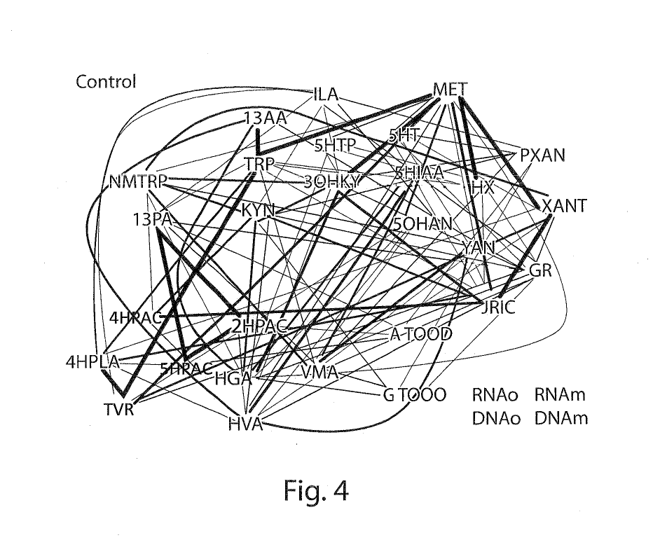

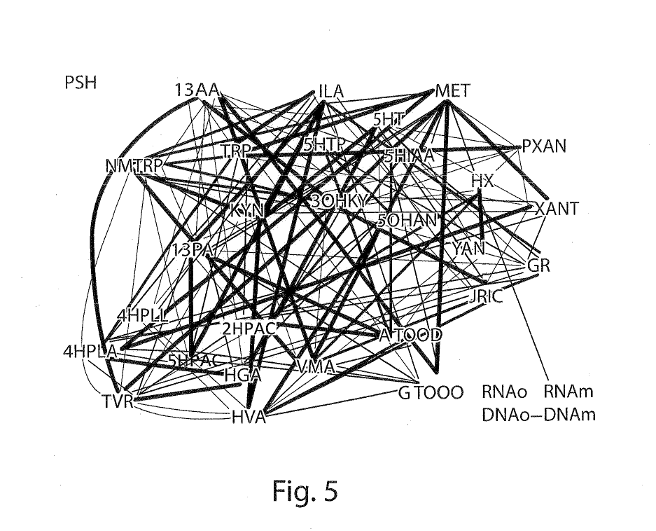

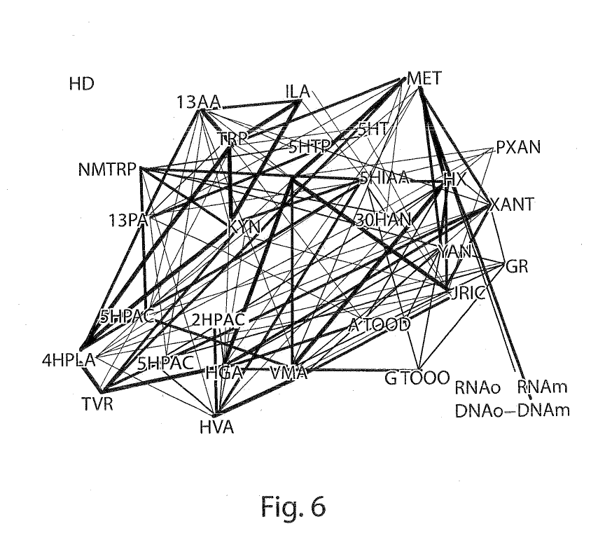

Metabolomics correlative mapping of compounds in Symptomatic Huntington's Disease, Presymptomatic Hutington's Disease and control subjects as groups of individuals is shown below in FIGS. 4-6, described below, as are the implications for therapeutic intervention.

FIGS. 4-6 show respectively the relationships between compounds in the tyrosine tryptophan purine sulfur amino acid pathways, markers of oxidative stress and links to Genomic and transcriptome i.d. processes for control subjects, pre symptomatic HD subjects, and Symptomatic HD subjects respectively. This establishes the linkages with feedback loops 1 and 5 between the metabolome genome and transcriptome.

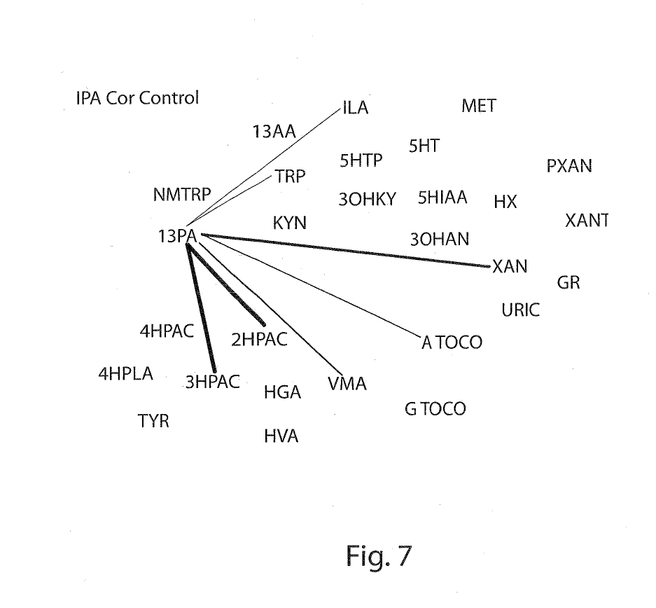

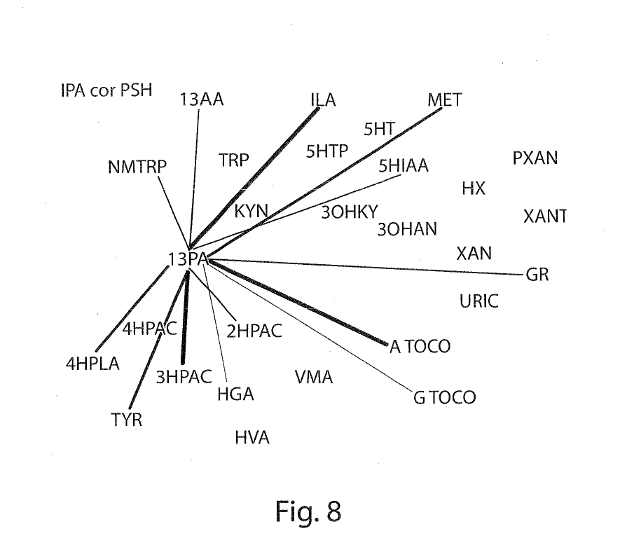

FIGS. 7-8 show the correlative link ages with the gut metabolite IPA for control, presymtomatic and symptomatic HD subjects respectively, and establishing the linkage of the gut mictobiome to the transcriptome and genome.

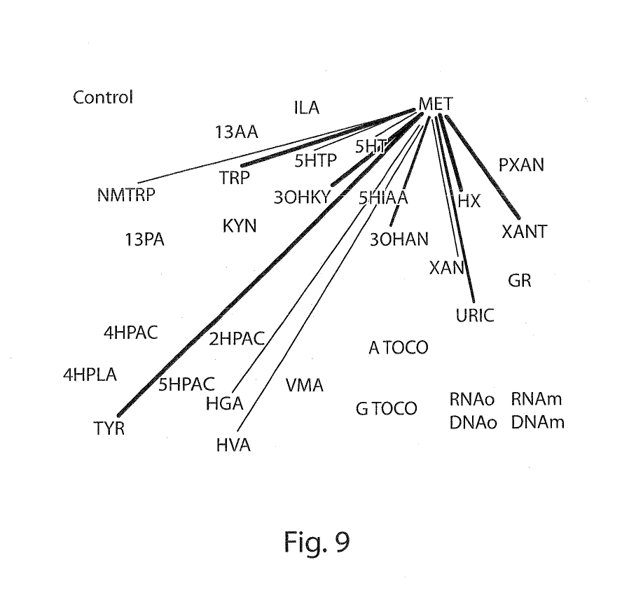

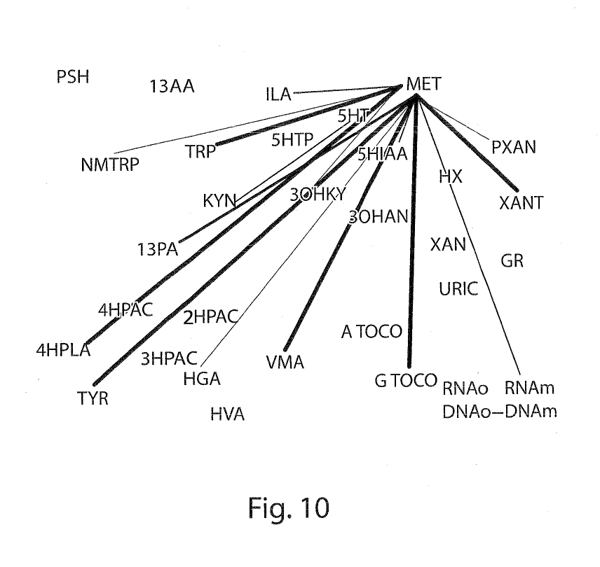

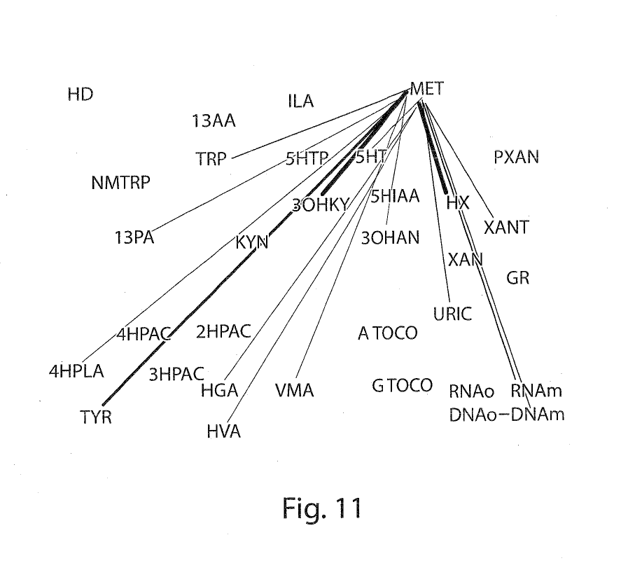

FIGS. 9-11 show the correlative relationships of methionine in the sulfur amino acid (SAM) pathway with other metabolites in the tyrosine trptophan and purine pathways, markers of oxidative stress gut micro biome status and DNA and RNA methylation and oxidative damage, and establishing the link between the SAM pathway (1 carbon metabolism folate and pterin synthesis).

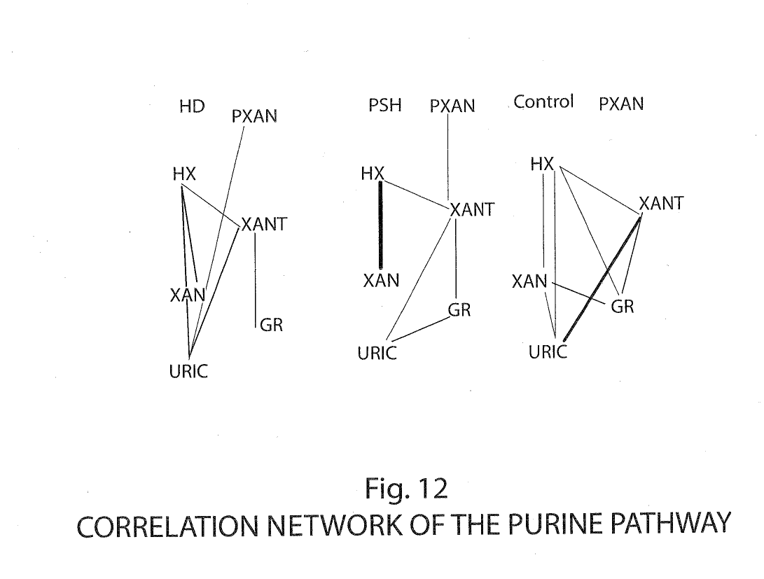

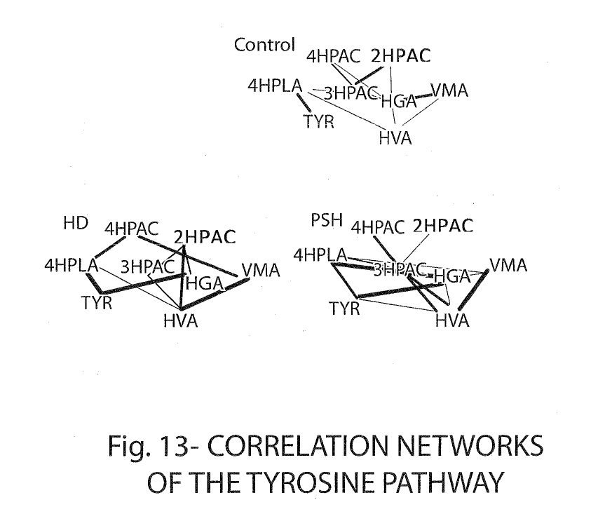

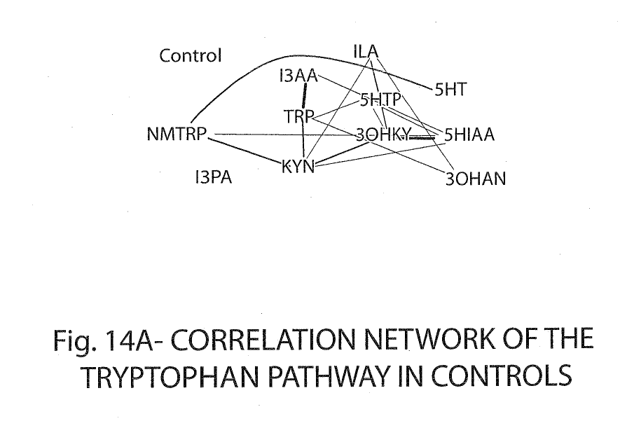

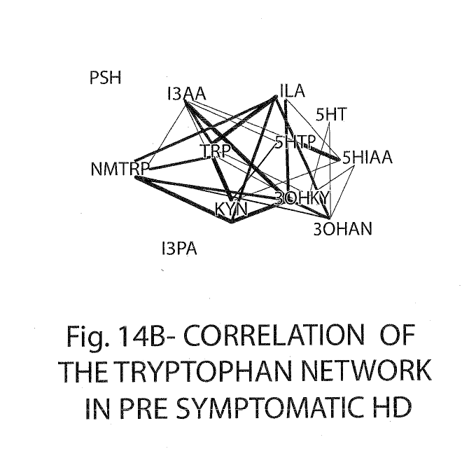

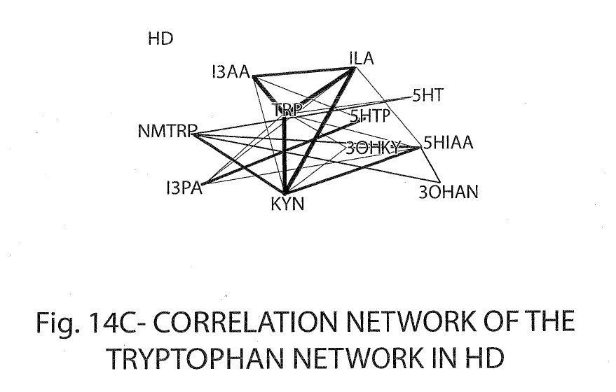

FIGS. 12-14 show the changes in specific pathways of tyrosine, tryptophan and purines which are linked to the SAM pathway and to each other by common enzyme variants and cofactors each figure shows the changes in the correlations inthese pathways from control subjects to presymptomatic and symptomatic HD subjects.

Changes in the correlation networks also categorize a disease state in a different manner and somewhat superior fashion than looking only at the levels of individual compounds as a pattern. Separations based on frequency distribution analysis or ratios of compounds following teaching in my patents prior U.S. Pat. Nos. 6,194,217 and 6,210,970, the contents of which are incorporated herein in their entireties, for instance, for known compounds in the HD vs. control subjects, result in correct classification rate (CCR=0.83) vs PLS-DA models with aCCR=0.72.

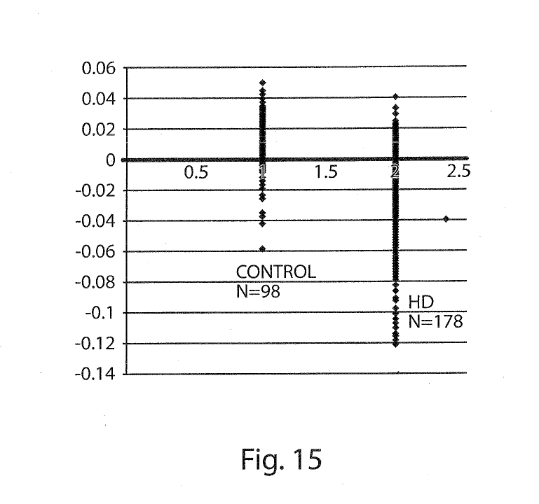

FIG. 15 shows the separation of HD and control subjects using the correlation frequency distribution approach for controls and HD.

Unlike the measurement of specific compounds or patterns for diagnostic or therapeutic insight these correlative patterns reflect the aggregate performance of the underlying enzymes co-factors and non enzymatic processes in the different classes of subjects. As such they in turn reflect the feedback control of the gut microbiome metabolme proteome transcriptome and genome. They also reflect throught the ineractions of the different pathways both the necessity and means of intervening in disease with multiple agents that manipulate and beneficially change the web of interactions as a whole.

In HD these correlative networks show progressive changes and break down of system control within and among the tyrosine, tryptophan, purine, sulfur amino acid, and oxidative protection and damage control, the epigenetic effects of variations in the ave pathways and mechanisms on DNA and RNA, and in the function of the gut microbiome. These then reflect the underlying aggregate performance of the enzymes in the proteome. These differences reveal several routes for simultaneous intervention at multiple points in the abberant control network. In conjunction with known defects in energetics and oxidative damage and as we have demonstrated for carbon metabolism or methylation, these interventions can be derived from evaluation of the metabolic pathways from such resources as the KEGG data base, to evaluate underlying enzymes associated genes and alternate pathway routes and from genomic data bases such as the genome wide association (GWAS) data base.

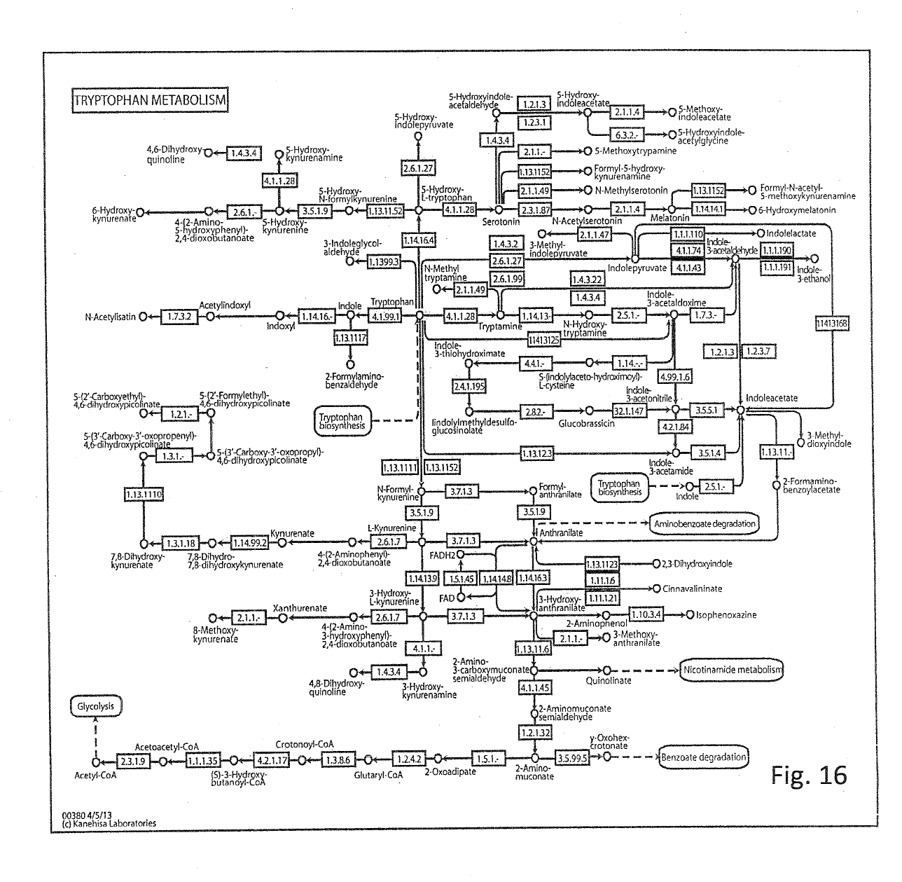

As a simplistic example from the tryptophan metabolic pathway in FIG. 16 if one wishes to intervene in HD with a kynurinine monoxoidas inhibitor to block the kynurinine branch of the tryptophan pathway at the transition to 3-hydroxykynurinine and subsequently produce more protective kynurenic acid and less of the intermediate metabolite of 3-hydroxykynurininequinolinic acid one must consider two other factors. First there are alternate routes to 3-hydroxyanthranillic acid the immediate quinolinic acid precursor through anthranillate that can be either enzymatically or by direct free radical attack converted to 3-hydroxyanthrinilic acid. Second the intermediate quinolinic acid leads to NAD and NADH that are essential for mitochondrial function. Thus intervention with a KMO inhibitor should be accompanied by supplementation with nicotinamide or niacin which provides an alternate route to NAD/NADH.

In this example of the approach, initial analysis of the metabolic pathways for tyrosine tryptophan, purines, SAM and folates, nicotinamide and NAD, and NADH formation and linking cofactors and enzymes and epigenetic and energetic phenomena suggests a multiple component intervention in early presymptomatic HD as follows:

Gut microbiome modification increase levels of beneficial compounds that are gut derived and decrease levels of compounds that produce stress in the system: The approach uses any or all of the following:
metabolic precursors favoring benefical components of the microbiome such as indole lactate a precursor in the metabolism of C. Sporogenes;
modification with inorganic absorbants for reducing harmful compounds such as cresols which load the P450 detoxification processes in the liver producing excess free radicals;
selected natural products from components, for instance, of the DASH Diet that are high in beneficial compounds such as indole propionate which also serve to modify the balance and distribution of species in the gut microbiome;
Creatine to provide and alternate route to energy generation and normalize the purine pathway;
S-andenosyl methionine or similar compounds in the SAM pathway to increase the flux through the SAM and folate pathway and correct of modify the abberant methylation in DNA and RNA;
Compounds in this pathway will also act as chelators for metal ions such as copper which are abberant in HD and may contribute to DNA damage by free radicals produced by cycling through the copper 1 and 2 transition in close proximity to DNA; and
Monitoring of urinary output of beneficial ions such as zinc will indicate whether these should be supplementally replaced;
5′ deoxy nucleotides phosphates to provide a reduction in the energy burden to repair oxidatively damaged DNA undergoing nucleotide excision repair;
CoQ10 to specifically reduce oxidative damage to the lipid bilayer in mitochondria;
Seleno-cysteine and/or selenite and pyridoxal to shift the metabolism of kynurinine towards kynurinateaway form the neurotoxic branch through quinolinate to NAD/NADH;
Nicotinamide/niacin to increase NAD and NADH for mitochondrial function; and
Tetrahydrobiopterin in the SAM/pterin pathway to normalize the branch of the tyrosine pathway leading through levodopa to dopamine.

An example of metabolic pathway analyzed using the correlative networks described for underlying enzymes in the tryptophan pathway is set forth in FIG. 16.

FIG. 16 is an example of the KEGG pathway data base network for tryptophan showing various routes to different compounds and interlinks with other pathways.

The Huntington's disease networks described above are one illustration of the generalized approach for utilizing the mapping of metabolomics proteomic genomic and transcriptomic interactions to suggest a way to alter the network of biochemical control in an individual in a beneficial fashion by addressing multiple points in a pathway rather than using a single drug with a putatuive target. It is an approach which is also useful in specifying or developing adjunctive therapeutic agents for use with existing drugs or therapies.

It can be similarly applied to network mapping for instance of non responders to SSRI drugs in depression, or neuroleptics in schizophrenia, hypertension, mild cognitive impairment, diabetes, Parkinsons, Alzheimers ALS, cardiovascular diseases including ischemic heard disease, gut disorders, cancers and head injury.

In summary the approach is:

### Use:

Cohorts of disease vs. control, or responder vs. non responder to therapy, or genetic risk vs non genetic risk subjects.

### Profile:

The coordinately bound metabolome in the periphery;

The covalently bound metabolme in the proteome;

The coordinately and covalently bound metabolome in DNA and RNA; and

The metabolome of the gut microbiome.

### Model:

Determine categorical separation of groups and most relevant single factors; and

Determine categorical separation of groups using correlative ratios of factors.

### Map:

The within and among pathway differences in the above cohorts using correlation networks.

### Determine:

The underlying enzymes, genes and processes that are revealed by the correlation networks; and

The compounds, co factors, and secondary effects that will allow intervention to beneficially modify the networks of interactions in the types of cohorts described above.

It is thus seen the old adage “you are what you eat” may be far truer than previously accepted. While the invention has been described in particular with connection with developing a treatment for Huntington's Disease, the invention has broad applicability to developing treatment for various other disease conditions including, but not limited to neurodegenerative diseases such as Parkingson's Disease, ALS, mild cognitive impairment, Altzhiemer's Disease; allergies; duct disorders such as celiac disease, inflammatory bowel disease and diverticulitis; failure to thrive, ischemic heart disease, depression, schitzophrenia, hypertension, arthritis and diseases of aging.

1. A method for developing a treatment for a disease condition in a living organism comprising modeling the metabolome of the gut microbiome of normal and diseased individuals to determine categorical separation of groups and most relevant single factors, or to determine categorical separation of groups using correlative ratios of factors.

2. A method for developing a treatment for a disease condition in a living organism, comprising mapping the within and among pathway differences of normal and diseased individuals in cohorts of categories selected from disease vs. control, responder vs. non responder to therapy, genetic risk vs. non genetic risk subjects, and well vs. non well aged subjects, using correlation networks.

3. A method for developing a treatment for a disease condition in a living organism comprising determining underlying enzymes, genes and processes of normal and diseased individuals that are revealed by the correlation networks and the compounds, cofactors, and secondary effects that allow intervention to beneficially modify the networks of interactions in the types of cohorts selected from disease vs. control, responder vs. non responder to therapy, genetic risk vs. non genetic risk subjects, and well vs. non well aged subjects.

4. The method of claim 1, comprising selecting cohorts of categories selected from disease vs. control, responder vs. non responder to therapy, genetic risk vs. non genetic risk subjects, and well vs. non well aged subjects.

5. The method of claim 1, comprising profiling coordinately bound metabolome in the periphery or in the proteome.

6. The method of claim 1, comprising profiling coordinately and covalently bound metabolome in DNA and RNA, or the metabolome of the gut microbiome.

7. The method of claim 2, comprising selecting cohorts of categories selected from disease vs. control, responder vs. non responder to therapy, genetic risk vs. non genetic risk subjects, and well vs. non well aged subjects.

8. The method of claim 2, comprising profiling coordinately bound metabolome in the periphery or in the proteome.

9. The method of claim 2, comprising profiling coordinately and covalently bound metabolome in DNA and RNA, or the metabolome of the gut microbiome.

10. The method of claim 3, comprising selecting cohorts of categories selected from disease vs. control, responder vs. non responder to therapy, genetic risk vs. non genetic risk subjects, and well vs. non well aged subjects.

11. The method of claim 3, comprising profiling coordinately bound metabolome in the periphery or in the proteome.

12. The method of claim 3, comprising profiling coordinately and covalently bound metabolome in DNA and RNA, or the metabolome of the gut microbiome.
